(19) United States
(12) Patent Application Publication
(10) Pub. No.: US 2007/0265915 A1
(43) Pub. Date: Nov. 15, 2007

(54) Method and system for encouraging wireless device users to send marketing messages via a wireless communications network

(75) Inventors: David Gould, Boulder, CO (US); Alec P. Karys, Framingham, MA (US)

Correspondence Address: KELLEY DRYE & WARREN LLP, 400 ALTLANTIC STREET , 13TH FLOOR, STAMFORD, CT, 06901, US

(73) Assignee: 2B Wireless, Inc., Boulder, CO (US)

(21) Appl. No.: 11/601,135

(22) Filed: Nov. 17, 2006

Related U.S. Application Data
(60) Provisional application No. 60/737,723, filed on Nov. 17, 2005.

(51) Int. Cl. G06Q 30/00

(52) U.S. Cl. 705/14

(57) ABSTRACT

A method for encouraging wireless device users to send marketing messages via a wireless communications network is disclosed. The method includes the steps of (1) sending the wireless device user, via the wireless communications network, a marketing message interface having the marketing message, an incentive, and fields allowing the wireless device user to identify one or more recipients and, optionally, to add an additional message; (2) receiving via the wireless communications network an overall message sent by the wireless device user and/or one of the recipients by use of the marketing message interface and, optionally, the additional message, together with identifier information about the one or more recipients; and (3) rewarding the sender of the overall message with the incentive. A system to implement the method is also disclose.

### CROSS-REFERENCE TO RELATED APPLICATIONS

This application relates to and takes priority from co-pending U.S. Provisional Patent Application Ser. No. 60/737,723 filed on Nov. 17, 2005 and titled, “METHOD AND SYSTEM FOR ENCOURAGING WIRELESS DEVICE USERS TO SEND MARKETING MESSAGES VIA A WIRELESS COMMUNICATIONS NETWORK,” which co-pending application is hereby incorporated by reference in its entirety.

### BACKGROUND OF THE INVENTION

1. Field of the Invention

The present invention relates generally to a system and method for using a wireless communications network to encourage wireless device users to forward marketing messages to other wireless device users via the wireless communications network. Specifically, the present invention relates to incentivizing a cell phone or other wireless communication device user to forward sales offers in the form of an email, srs message, instant message or other wireless communication message to other wireless devices users by providing rewards to the sending user for forwarding the wireless communication marketing message.

2. Background

“Viral Marketing” is a marketing term of art that was coined during the second half of the 1990s to describe any online marketing strategy or methodology that facilitated and encouraged large numbers of people to pass along a marketing message to family, friends, colleagues, acquaintances, and associates. This mode of marketing is best thought of as the marketing equivalent of a chain reaction. The goal is to conduct a marketing campaign that encourages a high “pass along” rate of some marketing message from person to person so that a large percentage of recipients forward the marketing message to a large number of acquaintances, who in turn pass along the message to another large group of acquaintances, and so on. A carefully designed marketing campaign can ripple outward extremely rapidly and if successful, the overall growth snowballs very quickly and the marketing message is spread to thousands or even millions of people.

Many business academics attribute the rise of true viral marketing to an early growth strategy that was employed by free web based email account suppliers. The strategy has been to first transmit an email message to the user with a simple tag attached at the bottom of every email. The tag encourages the recipient to get a free email account similar to the account of the sender. The tag is usually in the form an actionable hyperlink such that if the recipient clicked on the tag, they were immediately transferred to the sign up page within the account supplier's domain. The motivation for using the new email services is that it is a free e-mail address and accompanying service. In this model, many users can be contacted without the account supplier actively participating in the marketing program.

The email account supplier may stand back while users e-mail the marketing message to their own network of friends and associates, who in turn review the message, sign up for their own free e-mail service, and then forward the message onwards to an ever-increasing circle of friends and associates.

Since then, viral marketing has grown to the point where most every successful online venture has promulgated a viral marketing strategy. However, the market has largely been limited to email accounts accessed through personal computers.

The rapid rise of cell phone usage worldwide along with the concurrent deployment of high speed wireless data networks suggests that a large opportunity exists to employ commonly available devices such as cell phones, smart phones and personal digital assistants (PDA) as a medium through which marketers, vendors, content publishers, commerce sites, and so forth (hereafter collectively referred to as “marketers”) might wish to deploy effective, efficient viral marketing strategies (hereafter referred to as “marketing campaigns”).

A successful wireless marketing system will likely accomplish several desirable objectives. An objective of the wireless marketing system includes motivating the transmission of a marketing message by giving away something of value, i.e., a free product or service, discounts or coupons on a product or service, or entry into a sweepstakes or contest.

Another objective of the wireless marketing system is to provide for effortless transfer of the marketing message to others.

Still another objective is to provide scaling measures to easily adapt the system from small to very large marketing campaigns.

Yet another objective is to exploit common motivations and behaviors of wireless device users while utilizing existing wireless communication networks.

These and other objectives are achieved through use of the unique and novel wireless marketing system described in further detail below and in the appended claims.

### SUMMARY OF THE INVENTION

The present invention is a method and system for encouraging users of wireless devices (hereafter “wireless device users”) to transmit a message containing a marketing message (an “overall message”), enabling marketers to rapidly and efficiently conduct marketing campaigns through wireless devices and across wireless communications networks.

As used herein and in the appended claims, the term “wireless device” or “wireless devices” refers to portable, handheld wireless devices such as cell phones, smart phones, and personal digital assistants, but not to bulky, non-handheld, or non-portable devices such as desktop computers.

In a first aspect, the present invention includes a method of encouraging a wireless device user to send a marketing message via a wireless communications network, including composing an overall message for a wireless device that includes a marketing message, providing an incentive to be awarded when the wireless device user sends the marketing message to one or more recipients, providing user operable fields for the wireless device user to identify the one or more recipients and, optionally, to add additional information, identifying at least one recipient for the overall message, receiving the overall message, including the marketing message, the description of the incentive, and, optionally, the additional information added by the wireless device user, and identifier information about the at least one recipient identified by the wireless device user, sending the overall message to the at least one recipients and rewarding the wireless device user with the incentive.

In some embodiments the marketing message includes a predetermined text message, a hyperlink, a text description of a product or service, a web address, a telephone number, and/or a commons short code. The optional field may allow the wireless device user to add additional information, to select a predetermined text message, to enter a message manually to attach a photograph, audio file, voice file, or video file, or any combination of the foregoing.

The wireless device user may be allowed to identify the one or more recipients by name, telephone number, or e-mail address or select a recipient from a preexisting contact list residing on the wireless device user's wireless device.

In some embodiments the wireless device user is may identify the one or more recipients by providing the wireless device user with one or more recommended recipients based on predetermined recommendation or profiling criteria.

In some embodiments the incentive includes a giveaway, sweepstakes, rebate, discount, or coupon on a product or service.

In some embodiments the marketing message interface and/or the overall message further includes an advertisement.

In a second aspect, the present invention includes a method of encouraging a wireless device user to send a marketing message via a wireless communications network including sending the wireless device user, via the wireless communications network, a marketing message interface that includes the marketing message, a description of an incentive to be awarded when the wireless device user sends the marketing message to one or more recipients, and fields allowing the wireless device user to identify the one or more recipients and, optionally, to add additional information. The invention further includes receiving via the wireless communications network a copy of an overall message, which the wireless user is sending or has sent to one or more recipients, wherein the overall message comprises the marketing message, the description of the incentive, and, optionally, the additional information added by the wireless device user, and identifier information about the one or more recipients and rewarding the wireless device user with the incentive.

In a third aspect, the present invention includes a method of encouraging a recipient of a marketing message to forward the marketing message via a wireless communications network to one or more further recipients identified by the recipient, including receiving via the wireless communications network an overall message sent by a recipient, the overall message including the marketing message, a description of an incentive, and, optionally, additional information added by a wireless device user and/or the first or further recipient, wherein the marketing message was first sent to the recipient by the wireless device user via a wireless communications network, and identifier information about the one or more further recipients identified by the recipient. The invention further includes sending the overall message to the one or more further recipients identified by the recipient and rewarding the recipient with the incentive.

In a fourth aspect, the present invention includes a method of encouraging a recipient of a marketing message to pass on the marketing message via a wireless communications network to one or more further recipients identified by the recipient including receiving via the wireless communications network an overall message sent by a recipient, the overall message comprising the marketing message, a description of an incentive, and, optionally, additional information added by a wireless device user and/or the recipient, wherein the marketing message was first sent to the recipient by the wireless device user via a wireless communications network, and wherein the recipient is sending or has sent the overall message to one or more further recipients identified by the first or further recipient. The invention further includes identifier information about the one or more further recipients identified by the recipient and rewarding the recipient with the incentive.

In a fifth aspect, the present invention includes a system for conducting a marketing campaign via a wireless communications network having a marketing campaign server configured to send a wireless device user, via the wireless communications network, a marketing message interface comprising a marketing message, a description of an incentive, and fields allowing the wireless device user to identify at least one recipient or group of recipients and, optionally, to add additional information and control and monitor one or more marketing campaigns and receive, process, prioritize, monitor, route, and/or send an overall message received from a wireless device user and/or a recipient via the wireless communications network, wherein the overall message comprises the marketing message, the description of the incentive, and optional additional information added. The invention further includes an incentive management server in communication with the marketing campaign server, wherein the incentive management server is configured to award incentives associated with a particular marketing campaign.

In some embodiment the present invention includes a sender and recipient database server in communication with the marketing campaign server, wherein the sender and recipient database server is configured to store demographic information of wireless device users and/or recipients of overall messages, including wireless device users' and/or recipients' names and/or telephone numbers and, optionally, to provide the wireless device user with one or more recommended recipients based on predetermined recommendation or profiling criteria.

In some embodiments the present invention further includes a fault tolerance database server in communication with the marketing campaign server, wherein the fault tolerance database server is configured to store overall messages received by the marketing campaign server.

In some embodiments the present invention further includes an accounting and analysis server in communication with the marketing campaign server, wherein the accounting and analysis server is configured to calculate and/or verify costs relating to a marketing campaign and generate marketing campaign effectiveness reports and analyses.

In some embodiments the marketing campaign server possesses load balancing and/or clustering architectures. Further, all data stored on the marketing campaign server or the incentive management server or transmitted by the system is protected by security measures may include authentication, authorization, access control, tracking, and/or encryption.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 illustrates a system architecture according to one embodiment of the present invention;

FIG. 2 shows a marketing message interface according to one embodiment of the present invention;

FIG. 3 shows a logic flowchart according to one embodiment of the present invention; and

FIG. 4 shows another logic flowchart according to one embodiment of the present invention.

### DETAILED DESCRIPTION OF THE INVENTION

The present invention will now be described more fully with reference to the Figures in which at least one embodiment of the present invention is shown. The subject matter of this disclosure may, however, be embodied in many different forms and should not be construed as being limited to the embodiments set forth herein.

In the various embodiments described herein, each such embodiment may be implemented through the use of a computer code mechanism structured and arranged to carry out the various steps and functions corresponding to the elements, modules or steps in the various diagrams.

System Architecture

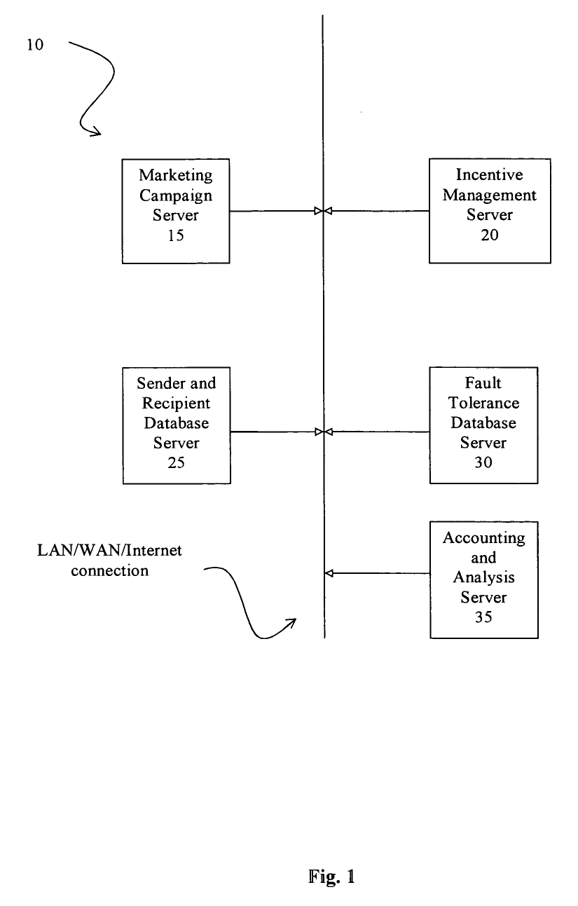

Referring now to the Figures, a typical system architecture according to one embodiment of the invention is shown in FIG. 1. There is a collection of interconnected application and database servers running on computer hardware whose function is to facilitate overall control of marketing campaigns, including traffic monitoring, error tracking and recovery, accounting and cost control, and data gathering and management. The system can accommodate high volumes of simultaneous marketing campaigns that would be initiated by one or more marketers. Note that a system in accordance with the present invention system can be completely hardware agnostic; that is, the individual component servers can occupy any computer hardware capable of hosting the appropriate server software. Also, the various components of the system need not reside in the same physical location; nor is it necessary for the system components to share the same computer hardware.

Components within a system in accordance with the present invention can be connected via wide area network (WAN), local area network (LAN), a wireless network or a wire line connected internet connection.

Marketing Campaign Server

A marketing campaign server 15 is a software application running on computer hardware. The marketing campaign server is designed to control and monitor each of the individual marketing campaigns and receive, process, prioritize, monitor, route and/or send each of the overall messages transmitted by wireless device users, as well as communicate with other components within the system. The marketing campaign server also receives the identifier information from wireless device users or recipient. These other components can include an incentive management server 20, a sender and recipient database server 25, a fault tolerance database server 30, and an accounting and analysis server 35. Also, the marketing campaign server sends the marketing message interface to the wireless device users via the wireless communications network.

Incentive Management Server

As discussed above, one factor often associated with marketing campaigns is an inducement that stimulates message senders and recipients to take action. Such inducements often take the form of free giveaways, sweepstakes, discounts, coupons, or any other promotion designed to induce consumers to pass along the marketer's marketing message. A system in accordance with the present invention fulfills these inducements via an incentive management server 20 communicatively connected to the marketing campaign server 15. The incentive management server 20 is a software application designed to track individual incentive programs associated with any individual marketing campaign. The incentive management server enters wireless device users who sent an overall message, as well as any overall message recipients who passed on an overall message to one or more further recipients, into the appropriate incentive program. The incentive management server awards incentives as per the marketer's requirements.

Sender and Recipient Database Server

The sender and recipient database server 25 is comprises one or more database software applications that store and/or compile, among other things, the phone number, name (if available) and other demographic information of the wireless device users and recipients that have participated in any way in any marketing campaign. It can also store information relating to the name, manufacturer, provider, or type of product and/or service that was the subject of any overall message in any marketing campaign in order to recommend and/or profile potential recipients to wireless device users. It is connected to the marketing campaign server 15 and receives sender and recipient demographic information therefrom.

Fault Tolerance Database Server

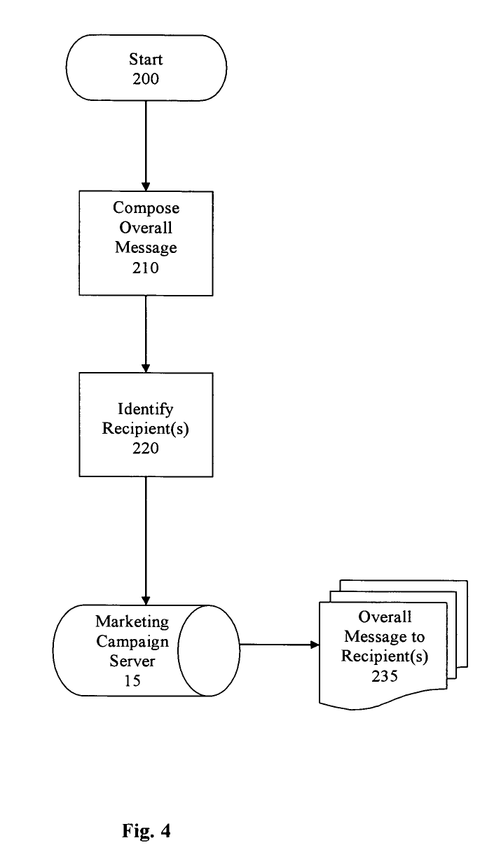

Due to the nature and real time sensitivity of the wireless networks, a fault tolerance database server 30 is implemented which includes a software application that will archive all overall messages sent during any marketing campaign so as to provide redundancy and to accommodate fault tolerance, optionally including suspend and resume processes. This may be especially important in the flow shown in FIG. 4 (described below) in which overall messages 210 are first received by the system before transmission to the recipient(s). The fault tolerance database server 30 is connected to the marketing campaign server 15 and receives therefrom the overall messages 210 to be archived.

Accounting and Analysis Server

The accounting and analysis server 35 is communicatively connected to the marketing campaign server 15 and comprises one or more software database applications that track system volumes and thereby provide for a method of calculating and/or verifying any costs related to a marketer's marketing campaign. Insofar as marketers desire to measure the effectiveness of their marketing campaigns, the accounting and analysis server 35 can be programmed to generate campaign effectiveness reports and analyses.

In order to accommodate the potentially high numbers of marketing campaigns and overall messages 210, each of the above components can be architected with scalability in mind. Scalability architecture can include load balancing and/or clustering. Furthermore, all data stored on or transmitted by the system can be tracked and/or encrypted. Multiple layers of security can be utilized to assure maximum security, including authentication, authorization, and/or access control.

There is a cost incurred by sending marketing message interfaces to wireless device users or sending/forwarding overall messages in accordance with the present invention; while this cost may be modest in the case of a small marketing campaign, it may grow large in the case of a large marketing campaign. To help defray or eliminate this cost, the marketing message interface 100 or overall message 210 can include an advertisement from a third party sponsor. In return, the sponsor pays some or all of the cost of sending the marketing message interface to wireless device users or sending/forwarding the overall message to the recipients; the sponsor may also be charged a premium where a high pass-on rate is expected. Additionally, the source of the marketed product and/or service can sponsor the provisioning of the marketing message interface 100 to wireless device users or the sending/forwarding of overall messages 210. For example, a marketing message interface 100 promoting a Sony plasma television can include a “banner ad” 110 for American Express credit cards; American Express would pay for the cost of sending the marketing message interface 100 to the wireless device users or the sending/forwarding of overall messages 210 to recipients.

Marketing Message Interface Provision

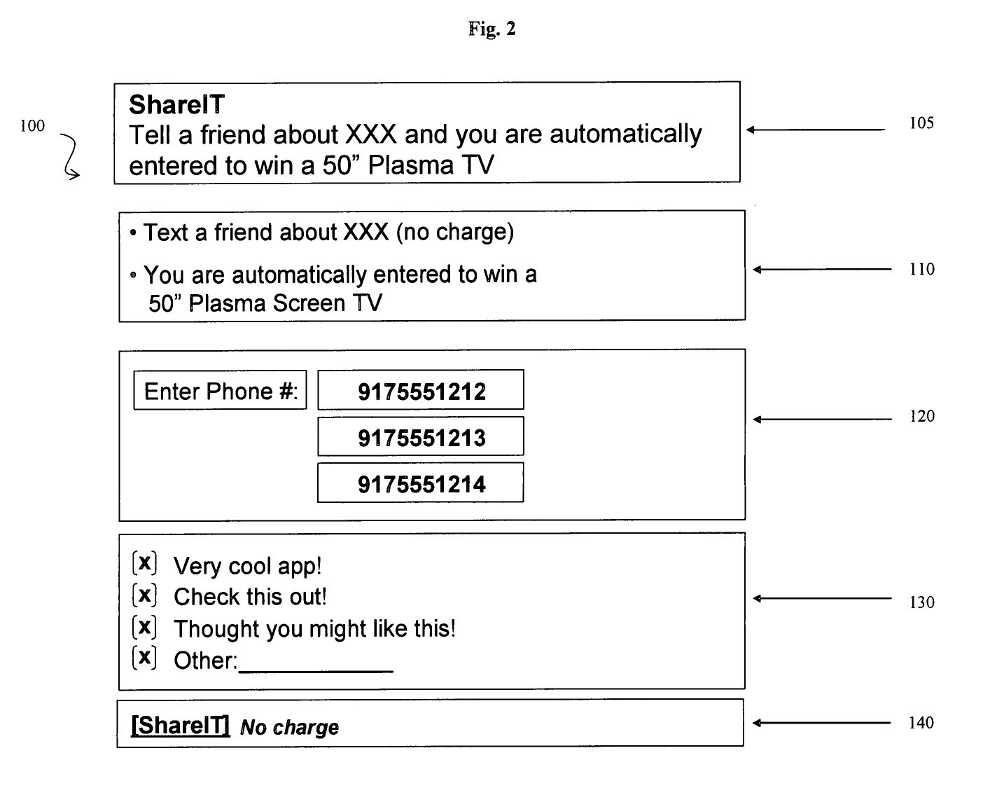

Referring now to FIG. 2 there is shown user interface 100 whereby marketers can embed their marketing message into an appropriately formatted template that wireless device users can use to include additional information and compose the overall message 210 they wish to transmit to a recipient.

The overall scheme for conducting a wireless marketing campaign in accordance with the present invention is designed to facilitate multiple functions. Those functions include providing wireless device users with a user interface containing a marketing message, an incentive to send the marketing message to at least one recipient, a field to allow the wireless device user to identify at least one recipient, and, optionally, fields that allow the wireless device user to add additional information.

Additionally, a wireless device user composes an overall message 210 by use of the marketing message interface 100. The format of the marketing message interface 100 allows wireless device users to rapidly, easily, and painlessly send an overall message 210.

The wireless device user transmits the overall message 210 across a wireless communications network. The overall message 210 contains the marketing message, a description of an incentive to be awarded when the wireless device user passes on the marketing message to one or more recipient(s) 220, and, optionally, additional information.

The system that, among other things, controls one or more concurrent marketing campaigns, facilitates the routing of overall messages 210, and/or analyzes the results of the marketing campaigns.

Finally, the present invention advantageously allows for efficient collecting and archiving data including demographic data, comments, actions taken, etc.

Wireless device users access the marketing message interface 100 on their cell phones or other PDA, whereby they can, among other things, identify the person or persons to whom they desire to transmit their overall message that contains, among other things, the marketing message. After the wireless device user has composed the overall message, the overall message is formatted for transmission across wireless communications networks and is transmitted across the wireless communications network to both the recipient(s) identified 220 by the wireless device user and to a marketing campaign server 15.

Subsequent to the composition of the overall message 210 by the wireless device user, the overall message 210 is first transmitted 230 to the marketer's marketing campaign server 15 and then transmitted on to the recipient(s) identified 220 by the wireless device user. This embodiment facilitates the use of incentives that may be time-sensitive, such as specials, coupons, and rebates with a short term expiration hour/date.

The marketing message interface 100, which can be authored using any standard software authoring tools, can be embedded within other wireless applications or can be used as a stand-alone marketing application. Either type of interface can be transmitted to the wireless device user via text messaging, multimedia messaging, downloading, streaming, or via any other wireless web networks using a combination of wireless application protocols (such as WAP/WML, etc.) and/or application programming interfaces (such as BREW, J2ME, etc). Regardless, the marketing message interface should adhere to the basic principles of viral marketing in the context of wireless devices, which often have severe usability limitations associated with data input (cell phone keypads are slow and cumbersome to use as keyboard input method) and data output (cell phone screens are typically very small when compared to traditional computer monitors).

The components of the marketing message interface 100 may include:
1. a field that contains the marketing message 105;
2. a field that contains a description of an incentive, which can be combined within the marketing message field or within the marketing message itself 110;
3. a field wherein recipient(s) can be identified 120; and
4. optionally, one or more fields that allow the wireless device user to include additional information in the overall message 130.
   Overall Message Composition

FIG. 2 illustrates one embodiment of the marketing message interface 100. Fields 105 and 110 represent application objects wherein marketers can communicate their marketing message. Please note that within the objects, the marketer not only promotes its product, XYZ, but also provides an incentive; in this instance, any wireless device user who sends an overall message containing the marketing message is automatically entered into a sweepstakes to win a free 50″ plasma TV. Field 120 provides for easy ways to enter any recipient identifier information such as a unique phone number, email address, or other electronic address (the “recipient address”) or identifier (e.g., a nickname) for a recipient. The wireless device user can use the wireless device keypad to input any standard alphanumeric character and thus enter any recipient's address. Additionally, the marketing message interface is compatible with standard wireless device firmware application programming interfaces such that the wireless device user can easily import any intended recipient's addresses that has been stored into a pre-existing contacts list that might be resident on his/her wireless device. Thus, a wireless device user can send the overall message to one or more recipients in at least the following ways: by simply entering one or more recipient identifiers, by importing one or more contacts from a contact list stored on the wireless device, and/or by importing one or more groups of contacts from among a contact list stored on the wireless device. The importation feature can readily obviate some of the data input limitations associated with wireless devices. Any of the foregoing identifier information about the one or more recipients is sent to the system (described below) and allows the system to route the overall message and/or to store the identifier information.

The marketing message can take the form of, among other things, a hyperlink, text description, Web address, phone number, commons short code (as such term is used in the cellular telephone industry), or such other information that allows the recipient(s) to take any action that may be desired by the marketer. The marketing message can also take the form of a ‘clickable’ multi media object that contains an embedded video, audio, or other multimedia file that can effectively be used to further convey the marketing message. Similarly, the marketing message can itself be an audio or video clip in addition to or in place of a text marketing message. Furthermore, the marketing message can contain the incentive program associated with the marketing campaign. For example, the marketing message field can contain a small photo object within the marketing message interface 100 as well as a short text description and a hyperlink to the marketer's Web site. In another example, the marketing message is a brief video that shows the product and/or service that is the subject of the marketing campaign; the video can, if desired, conclude by showing the incentive.

One benefit of a successful marketing campaign in accordance with the present invention is affording the wireless device user an option to quickly personalize the overall message 210 by adding additional information. This is important because any recipient might quickly intuit, upon the receipt of the overall message, that the overall message is coming from a trusted friend, family member, or associate and not from some uninvited solicitor. Field 130 within FIG. 2 illustrates an example of an optional field within the marketing message interface 100 that is designed to facilitate quick, easy message personalization given the inherent limitations associated with wireless devices. In this example, the marketer chose to include four message fields in the marketing message interface 100, three of which are pre-formatted so that by merely checking the appropriate box, the wireless device user can quickly choose a pre-formatted text message, thus avoiding the inconvenience of having to key in a unique message. However, in accordance with the present invention, the wireless device user can enter any sort of message, not only a pre-formatted text message as shown in FIG. 2. The fourth field allows for added degrees of personalization insofar as the wireless device user elects to enter a unique message. Notwithstanding the previous example, the additional information field can also include the ability to attach any multimedia files, including photos, audio files, recorded voice messages, video, and so forth. This enhanced personalization ability is especially useful given the proliferation of camera phones and picture messaging. Application of such an enhanced personalization feature would, for example, allow a wireless device user to take a picture of a particular item using a camera phone and place the photo within the overall message.

As detailed above, wireless device users have several ways to designate recipients of overall messages 210. To make the recipient identification process even easier for wireless device users, particularly where recipient addresses or phone numbers must be entered via a keypad, the present invention can provide an “intelligent agent” feature to wireless device users. The intelligent agent accesses recipient data previously stored on a sender and recipient database server that is part of the system of the present invention described in detail below. The intelligent agent can provide a “look-ahead” functionality that automatically populates the recipient field after the wireless device user has entered a few digits or characters; the automatically populated field can be accepted by the wireless device user to save time. For example, if the name William Jackson is stored on the sender and recipient database server under the wireless device user's profile, after the wireless device user types in “w” using the keypad, the intelligent agent populates the field with “William Jackson,” saving the wireless device user time in composing the overall message.

Furthermore, the intelligent agent can recommend to the wireless device user one or more recipients based on the data previously stored on the sender and recipient database server. Recommendations can be made according to predetermined recommendation criteria, such as recommending the recipients to whom the wireless device user sent an overall message 210 during a prior marketing campaign. Analogous to the previous example, the intelligent agent can automatically populate a recipient field with “William Jackson” even before the wireless device user has entered any numbers or characters in the recipient field(s), if the recommendation of William Jackson is in accordance with the predetermined recommendation criteria. Moreover, using the data stored on the sender and recipient database server, the intelligent agent can “profile” the recipients of previous overall messages 210 according to predetermined profiling criteria to recommend one or more recipients to the wireless device user. Such predetermined profiling criteria can include, without limitation, the name, manufacturer, provider, or type of product and/or service. For example, if the wireless device user previously sent to William Jackson an overall message 210 that marketed a 50-inch plasma television, and where plasma televisions have a type designation in the predetermined profiling criteria of “consumer electronics,” the intelligent agent can recommend William Jackson as a recipient of any future overall message composed by the wireless device user that markets consumer electronics.

Transmission

Once a wireless device user composes the overall message 210, the wireless device user then transmits the overall message 230. FIG. 2 also illustrates a standard <enter>hyperlink 140 (here, [ShareIT]) whereupon clicking, the application initiates error checks, formatting (as required by the wireless device user's wireless carrier), and transmission across the appropriate wireless communications network.

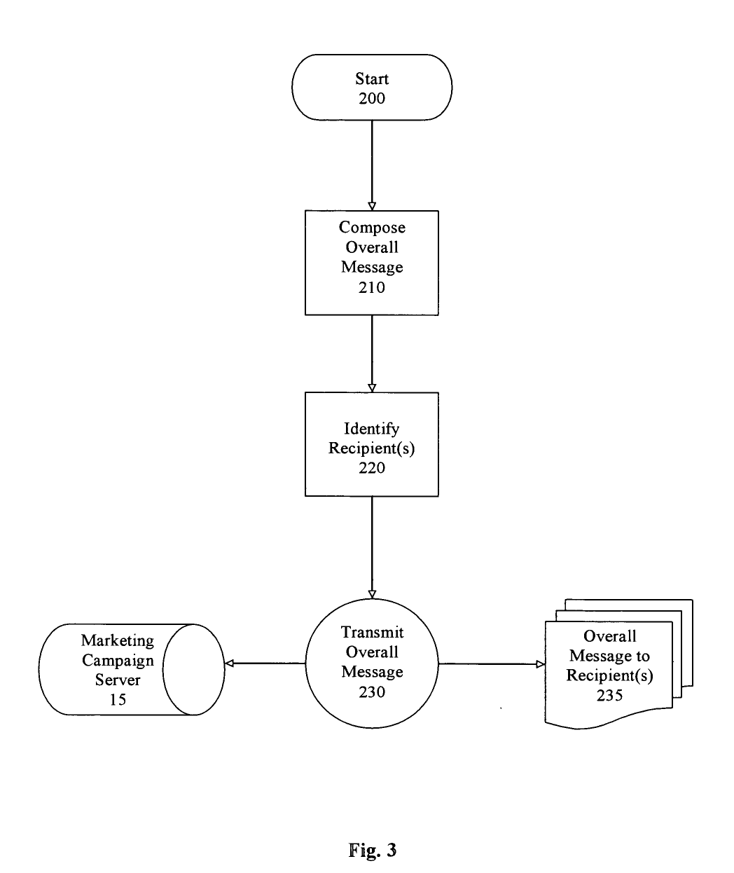

Referring now to FIG. 3, an overall message 210 is composed and recipient(s) are identified 220 by the wireless device user. The overall message 210 is then transmitted 230 the marketing campaign server and to the overall message recipients 235.

As shown in FIG. 4, the overall message 210, together with the identifier information about the one or more recipients identified 220 by the wireless device user, may be transmitted first to the marketing campaign server 15, then routed by the marketing campaign server and transmitted to the recipient(s) 235 based on the identifier information provided by the wireless device user.

Recipients of overall messages have the opportunity to pass along the overall message to one or more further recipients and partake in the incentive program that corresponds to the marketing message. Any recipients may also be given the opportunity to add additional information to the overall message 210 prior to sending. When any recipient passes along an overall message to one or more further or additional recipients, the recipient is rewarded with the appropriate incentive. In any case, the marketing message can continue to be passed along indefinitely to any number of further recipients, with each further recipient in the chain becoming generally a “recipient” having the chance to pass on the marketing message to “further recipient(s)” and receive the corresponding incentive.

The method and system of the present invention require a wireless communications network that can be used to transmit the wireless device user's overall message 210 to the marketing campaign server 15. Wireless data is transmitted using existing cell phone companies or other wireless communications network providers as distribution intermediaries. The wireless communications network provides for the passing of the overall message 210 from the wireless device through the carriers' networks and related systems on to the marketing campaign server 15 and/or recipient(s) 220. While the method and system of the present invention is optimized for use through wireless devices, the wireless communications network can be, without limitation, any wireless or wireline Internet network, wireless or wireline data network, wireless or wireline voice network, or wireless or wireline data or voice technology.

It will be apparent to one of skill in the art that described herein is a novel system and method for Encouraging Wireless Device Users To Send Marketing Messages Via A Wireless Communications Network. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. A method of encouraging a wireless device user to send a marketing message via a wireless communications network, the method comprising the steps of:
(a) composing an overall message for a wireless device comprising the steps of
(i) composing a marketing message
(ii) providing an incentive to be awarded when the wireless device user sends the marketing message to one or more recipients;
(iii) providing user operable fields for the wireless device user to identify the one or more recipients and, optionally, to add additional information;
(b) identifying at least one recipient for the overall message;
(c) receiving the overall message, including the marketing message, the description of the incentive, and, optionally, the additional information added by the wireless device user; and identifier information about the at least one recipient identified by the wireless device user;
(d) sending the overall message to the at least one recipients and
(e) rewarding the wireless device user with the incentive.

2. The method of claim 1, wherein the marketing message comprises a predetermined text message, a hyperlink, a text description of a product or service, a web address, a telephone number, and/or a commons short code.

3. The method of claim 1, wherein the optional field allowing the wireless device user to add additional information allows the wireless device user to select a predetermined text message.

4. The method of claim 1, wherein the optional field allowing the wireless device user to add additional information allows the wireless device user to enter a message.

5. The method of claim 1, wherein the optional field allowing the wireless device user to add additional information allows the wireless device user to attach a photograph, audio file, voice file, or video file, or any combination of the foregoing.

6. The method of claim 1, wherein the wireless device user is allowed to identify the one or more recipients by name, telephone number, or e-mail address.

7. The method of claim 1, wherein the wireless device user is allowed to identify the one or more recipients by selecting from a preexisting contact list residing on the wireless device user's wireless device.

8. The method of claim 1, wherein the wireless device user is allowed to identify the one or more recipients by providing the wireless device user with one or more recommended recipients based on predetermined recommendation or profiling criteria.

9. The method of claim 1, wherein the incentive comprises a giveaway, sweepstakes, rebate, discount, or coupon on a product or service.

10. The method of claim 1, wherein the marketing message interface and/or the overall message further comprise an advertisement.

11. A method of encouraging a wireless device user to send a marketing message via a wireless communications network comprising the steps of:
(a) sending the wireless device user, via the wireless communications network, a marketing message interface comprising:
(i) the marketing message,
(ii) a description of an incentive to be awarded when the wireless device user sends the marketing message to one or more recipients, and
(iii) fields allowing the wireless device user to identify the one or more recipients and, optionally, to add additional information;
(b) receiving via the wireless communications network
(i) a copy of an overall message, which the wireless user is sending or has sent to one or more recipients, wherein the overall message comprises the marketing message, the description of the incentive, and, optionally, the additional information added by the wireless device user, and
(ii) identifier information about the one or more recipients; and
(c) rewarding the wireless device user with the incentive.

12. The method of claim 1 1, wherein the marketing message comprises a predetermined text message, a hyperlink, a text description of a product or service, a web address, a telephone number, and/or a commons short code.

13. The method of claim 11, wherein the optional field allowing the wireless device user to add additional information allows the wireless device user to select a predetermined text message.

14. The method of claim 11, wherein the optional field allowing the wireless device user to add additional information allows the wireless device user to enter a message.

15. The method of claim 11, wherein the optional field allowing the wireless device user to add additional information allows the wireless device user to attach a photograph, audio file, voice file, or video file, or any combination of the foregoing.

16. The method of claim 11, wherein the wireless device user is allowed to identify the one or more recipients by name, telephone number, or e-mail address.

17. The method of claim 11, wherein the wireless device user is allowed to identify the one or more recipients by selecting from a preexisting contact list residing on the wireless device user's wireless device.

18. The method of claim 11, wherein the wireless device user is allowed to identify the one or more recipients by providing the wireless device user with one or more recommended recipients based on predetermined recommendation or profiling criteria.

19. The method of claim 11, wherein the incentive comprises a giveaway, sweepstakes, rebate, discount, or coupon on a product or service.

20. The method of claim 11, wherein the marketing message interface and/or the overall message further comprise an advertisement.

21. A method of encouraging a recipient of a marketing message to forward the marketing message via a wireless communications network to one or more further recipients identified by the recipient, the method comprising the steps of:
(a) receiving via the wireless communications network
(i) an overall message sent by a recipient, the overall message comprising the marketing message, a description of an incentive, and, optionally, additional information added by a wireless device user and/or the first or further recipient, wherein the marketing message was first sent to the recipient by the wireless device user via a wireless communications network, and
(ii) identifier information about the one or more further recipients identified by the recipient;
(b) sending the overall message to the one or more further recipients identified by the recipient; and
(c) rewarding the recipient with the incentive.

22. A method of encouraging a recipient of a marketing message to pass on the marketing message via a wireless communications network to one or more further recipients identified by the recipient, the method comprising the steps of:
(a) receiving via the wireless communications network
(i) an overall message sent by a recipient, the overall message comprising the marketing message, a description of an incentive, and, optionally, additional information added by a wireless device user and/or the recipient,
(1) wherein the marketing message was first sent to the recipient by the wireless device user via a wireless communications network, and
(2) wherein the recipient is sending or has sent the overall message to one or more further recipients identified by the first or further recipient; and
(ii) identifier information about the one or more further recipients identified by the recipient; and
(b) rewarding the recipient with the incentive.

23. A system for conducting a marketing campaign via a wireless communications network comprising:
(a) a marketing campaign server configured to:
(i) send a wireless device user, via the wireless communications network, a marketing message interface comprising a marketing message, a description of an incentive, and fields allowing the wireless device user to identify at least one recipient or group of recipients and, optionally, to add additional information; and
(ii) control and monitor one or more marketing campaigns and receive, process, prioritize, monitor, route, and/or send an overall message received from a wireless device user and/or a recipient via the wireless communications network, wherein the overall message comprises the marketing message, the description of the incentive, and optional additional information added; and
(b) an incentive management server in communication with the marketing campaign server, wherein the incentive management server is configured to award incentives associated with a particular marketing campaign.

24. The system of claim 23, further comprising a sender and recipient database server in communication with the marketing campaign server, wherein the sender and recipient database server is configured to store demographic information of wireless device users and/or recipients of overall messages, including wireless device users' and/or recipients' names and/or telephone numbers and, optionally, to provide the wireless device user with one or more recommended recipients based on predetermined recommendation or profiling criteria.

25. The system of claim 23, further comprising a fault tolerance database server in communication with the marketing campaign server, wherein the fault tolerance database server is configured to store overall messages received by the marketing campaign server.

26. The system of claim 23, further comprising an accounting and analysis server in communication with the marketing campaign server, wherein the accounting and analysis server is configured to calculate and/or verify costs relating to a marketing campaign and generate marketing campaign effectiveness reports and analyses.

27. The system of claim 23, wherein the marketing campaign server possesses load balancing and/or clustering architectures.

28. The system of claim 23, wherein all data stored on the marketing campaign server or the incentive management server or transmitted by the system is protected by security measures including authentication, authorization, access control, tracking, and/or encryption.

29. The system of claim 23, wherein the wireless communications network comprises a wireless Internet network, a wireless data network, or a wireless voice network.

30. The system of claim 23, wherein the incentive comprises a giveaway, sweepstakes, rebate, discount, or coupon on a product or service.
